(19) United States
(12) Patent Application Publication
(10) Pub. No.: US 2009/0168175 A1
(43) Pub. Date: Jul. 2, 2009

(54) CLOSING MECHANISM FOR LENS SHUTTER

(75) Inventor: Akimitsu Ishizuka, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/242,481

(22) Filed: Sep. 30, 2008

(30) Foreign Application Priority Data
Dec. 26, 2007 (JP) 2007-335308

(51) Int. Cl. G02B 23/16

(52) U.S. Cl. 359/511; 396/448

(57) ABSTRACT

According to one embodiment, a closing mechanism is configured so that an engaging end portion of a handle is engaged with an engagement piece of a shutter in an open position while a handle for carrying a projector is being drawn out to a carrying position, and the shutter is moved toward a closed position. The positions of the engaging end portion and/or the engagement piece along a sliding direction are set so that an urging force of an α-spring in a closing direction acts immediately before the handle is fully drawn out.

### CROSS-REFERENCE TO RELATED APPLICATIONS

This application is based upon and claims the benefit of priority from Japanese Patent Application No. 2007-335308, filed Dec. 26, 2007, the entire contents of which are incorporated herein by reference.

### BACKGROUND

1. Field

One embodiment of the invention relates to a closing mechanism configured to close a lens shutter, which covers a lens of an electronic apparatus, such as a projector, in association with an operation for drawing out a carrying handle.

2. Description of the Related Art

In a conventionally-known lens protection device for protecting a lens of a liquid crystal projector, a lens cover is fitted with a handle for carrying the projector. It is disclosed by, for example, Jpn. Pat. Appln. KOKAI Publication No. 11-14958 (FIGS. 1 to 3).

If a user holds and suspends the handle to carry the liquid crystal projector, the body of the projector slides or rocks with respect to the lens cover so that the cover overspreads the lens.

With this arrangement, the user who carries the projector can avoid failing to close the lens cover, so that the lens can be protected securely.

In the device disclosed by the aforesaid patent document, however, the lens cover, fitted with the handle, should inevitably be made so large that the device configuration is correspondingly large and heavy. If the liquid crystal projector is in an operating state when the relatively large lens cover is opened or closed, moreover, it is necessary to secure a relatively wide surrounding space for the cover to be opened or closed. Thus, the installation space for the device must be widened correspondingly.

In order to locate the lens cover of this device in a closed position to protect the lens without regard to the state of the projector, whether in operation or being carried, furthermore, the handle must be slid or rocked to a carrying position. In consequence, the lens cover cannot be operated independently of the handle.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not limit the scope of the invention.

FIG. 1 is an external perspective view of a projector according to one embodiment of the invention, taken diagonally from the right front;

FIG. 2 is an external perspective view of the projector of FIG. 1 with its lens shutter closed, taken diagonally from the left front;

FIG. 3 is an external perspective view of the backside for illustrating an interlocking mechanism that moves the shutter in association with an operation for drawing out a handle shown in FIG. 2;

FIG. 4 is a front view for illustrating an urging mechanism for the shutter of FIG. 3;

FIG. 5 is a partially enlarged view showing an α-spring of FIG. 4 in a contracted state; and

FIG. 6 is a partially enlarged, external perspective view for illustrating a principal part of the interlocking mechanism for the handle and the shutter of FIG. 3.

### DETAILED DESCRIPTION

Various embodiments according to the invention will be described hereinafter with reference to the accompanying drawings. In general, according to one embodiment of the invention, a closing mechanism for a lens shutter includes an interlocking mechanism that moves the lens shutter to a closed position in association with an operation for drawing out a handle in an electronic apparatus to a carrying position.

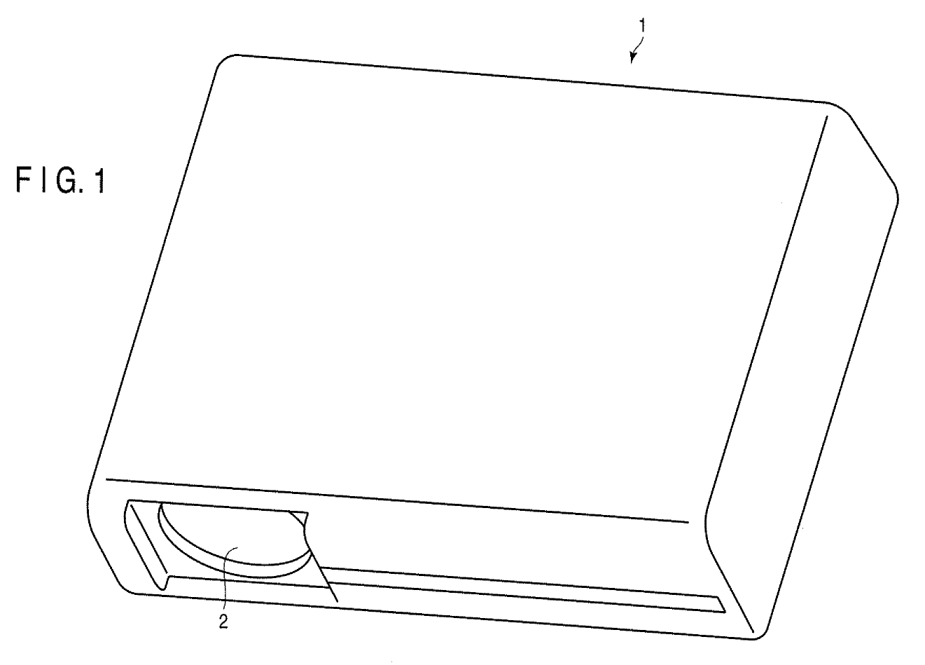

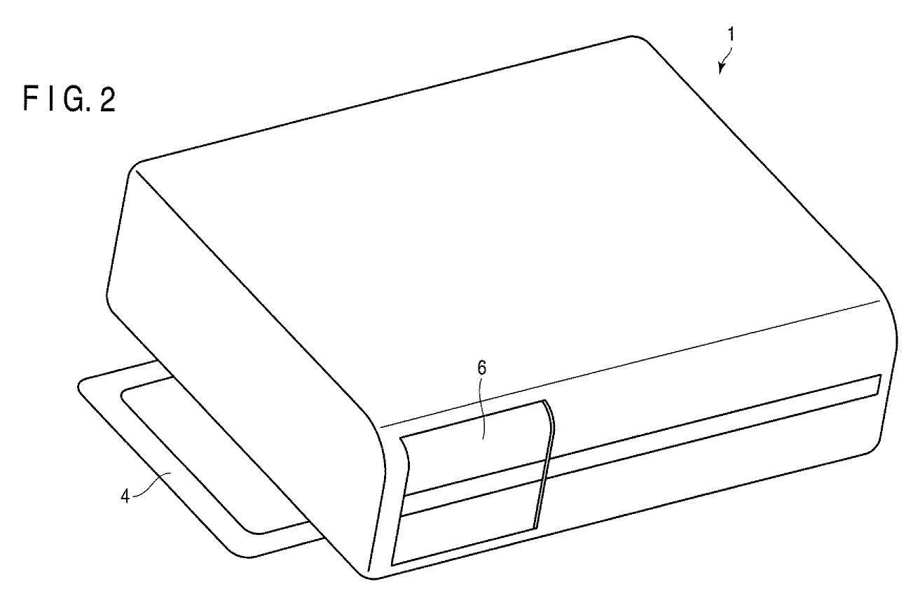

FIG. 1 shows an external perspective view of a projector 1 as an electronic apparatus according to the embodiment of the invention, taken diagonally from the right front. FIG. 2 shows an external perspective view of the projector 1 taken diagonally from the left front.

The projector 1 is provided with a lens 2, which is situated on the left-hand side of its front face, and a carrying handle 4 on the left-hand side of its bottom surface. As shown in FIG. 2, the handle 4 is drawn out from the left-hand side of a housing of the projector 1 when it is to be used. The lens 2 is fitted with an open/close shutter 6 (hereinafter referred to simply as the shutter 6). The shutter 6 is open in the state shown in FIG. 1 and closed in the state shown in FIG. 2.

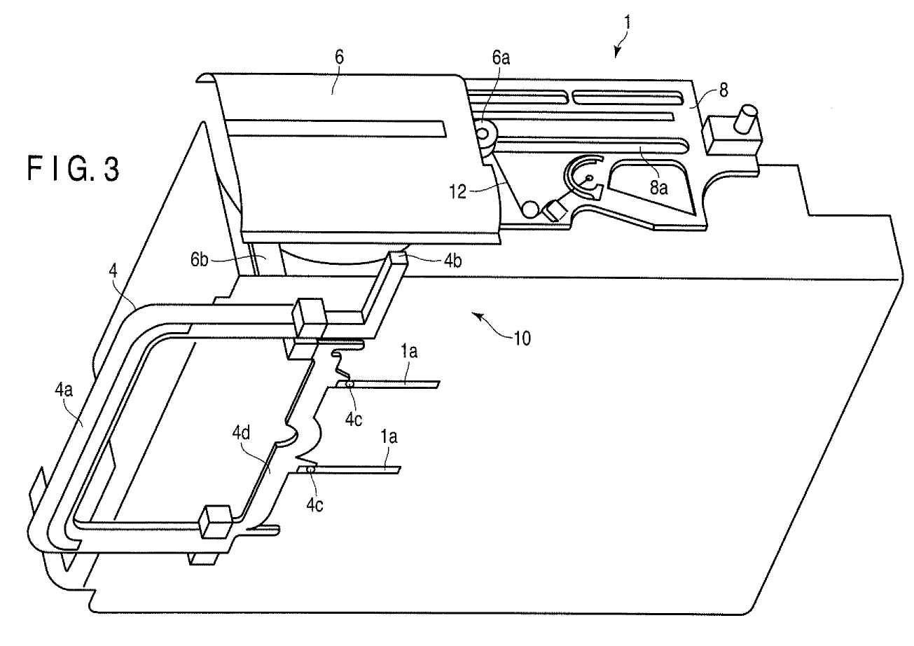

FIG. 3 shows a perspective view of a principal part of the projector 1 taken from the backside and illustrates a closing mechanism 10. The closing mechanism 10 shifts the shutter 6 to the closed position of FIG. 2 in association with the operation for drawing out the handle 4.

The shutter 6 is slidably mounted on a guide member 8 having an elongated slide slot 8a that extends in its opening/closing direction (or horizontally in FIG. 3). Specifically, a boss portion (not shown) that protrudes inward from a tongue 6a that is located at the distal end (right-hand end of FIG. 3) of the shutter 6 with respect to the opening direction is slidably passed through the slide slot 8a of the guide member 8. The shutter 6 is slidable along the slide slot 8a. In FIG. 3, the shutter 6 is in the closed position. Further, an engagement piece 6b in the form of a substantially rectangular plate integrally protrudes downward from the lower end side near the distal end of the shutter 6 with respect to the closing direction.

The handle 4 includes a grip portion 4a that extends along the left-hand side surface of the housing. Two opposite ends of the grip portion 4a are bent substantially at right angles and extend to the right of FIG. 3 along the reverse surface of the projector 1. An engaging end portion 4b that extends substantially parallel to the grip portion 4a is provided on one end of the bent parts. The engaging end portion 4b is configured to engage with the engagement piece 6b of the shutter 6 when the handle 4 is drawn out, and serves to move the shutter 6 toward the closed position in association with the operation for drawing out the handle 4.

The handle 4 is provided with a communication plate portion 4d integrally including two pins 4c that are slidably passed through two slide grooves 1a in the reverse surface of the housing of the projector 1, individually. As the pins 4c are slid individually along the slide grooves 1a, the handle 4 can be horizontally (FIG. 3) drawn out of or retracted into the housing. In the state shown in FIG. 3, the handle 4 is drawn out from the retracted position to the carrying position.

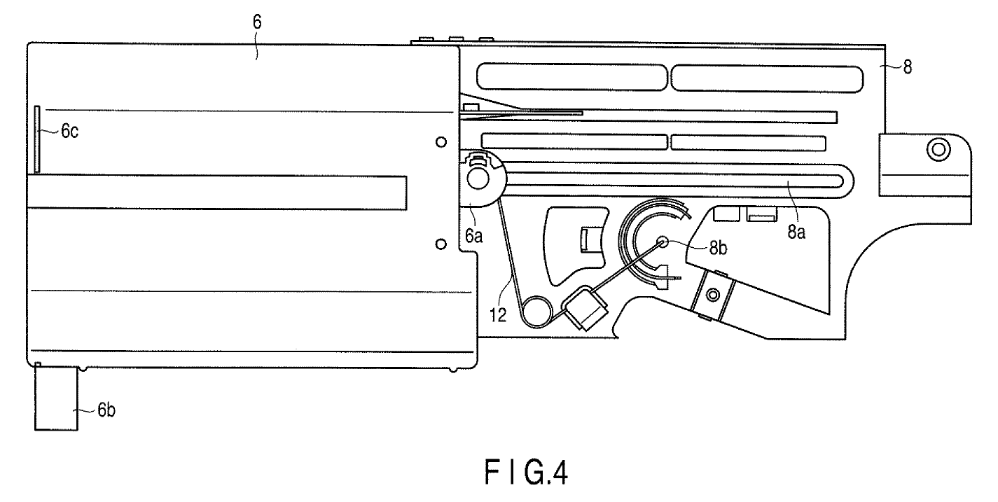

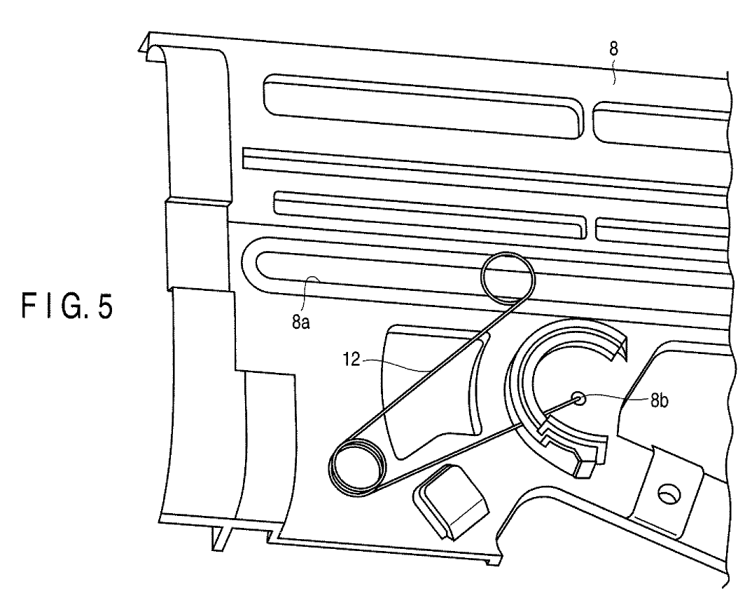

As shown in FIG. 4, an α-spring 12 that functions as an urging mechanism of this invention is mounted between the shutter 6 and the guide member 8. As shown in the enlarged view of FIG. 5, the central part of the α-spring 12 is wound a plurality of times like a coil such that an urging force is generated to open the opposite ends of the spring. Further, one end of the α-spring 12 is wound in a circle.

The boss portion (not shown) that inwardly protrudes from the tongue 6a of the shutter 6 toward the slide slot 8a of the guide member 8 is passed through the annular one end of the α-spring 12. Thus, the one end of the spring 12 is connected to the shutter 6. Further, the other end of the spring 12 is bent substantially at right angles toward the guide member 8, passed through a pinhole 8b in the guide member 8, and connected to the guide member 8.

The α-spring 12 urges the shutter 6 that is being slid from the open position to the closed position toward the closed position. Further, the spring 12 urges the shutter 6 that is being slid from the closed position to the open position toward the open position.

Thus, when the shutter 6 is located in the closed position shown in FIGS. 3 and 4, the α-spring 12 urges the shutter to the left as illustrated, and its coiled central part is situated in the illustrated position.

A lug 6c of the shutter 6 in this state is moved to the right as illustrated, resisting the urging force of the α-spring 12, so that the shutter 6 is slid to the opening direction (or to the right as illustrated). Thereupon, the annular one end of the α-spring 12, along with the boss portion of the shutter 6, slides in the opening direction along the slide slot 8a and is contracted, as shown in FIG. 5. In this state, the α-spring 12 still urges the shutter 6 in the closing direction.

If the shutter 6 is further slid in the opening direction to get beyond a critical point, the coiled central part of the α-spring 12 widely rotates clockwise (as illustrated) around the pinhole 8b of the guide member 8. Thereafter, the shutter 6 that is connected to the one end of the α-spring 12 is urged toward its open position.

When this is done, the critical point is a point such that the pinhole 8b and the annular one end of the spring 12 are aligned substantially at right angles to the direction in which the shutter 6 slides. After the critical point is passed, the shutter 6 is automatically shifted to the open position without being subjected to any external force even if the lug 6c is released from hold.

In sliding the shutter 6 in the open position toward the closed position, on the other hand, the shutter 6 is slid in the closing direction by an external force so that the critical point is passed. FIG. 5 shows the shape of the α-spring 12 immediately after the critical point is passed as the shutter 6 is moved in the closing direction. After the critical point is passed, the shutter 6 is automatically shifted to the closed position by the urging force of the spring 12 without being subjected to any external force.

The critical point stated herein is only an indication point for the change of the direction in which the urging force of the α-spring 12 acts. Actually, the slide of the shutter 6 is hindered by various frictional forces, such as that between the boss portion of the shutter 6 and the slide slot 8a of the guide member 8. Therefore, the critical point at which the shutter 6 actually starts to move has an allowance.

According to the present embodiment, the shutter 6 is designed so that the critical point at which it starts to move in the closing direction is slid from the open position toward the closed position for ⅔ of the entire stroke (mentioned later) of the handle 4. In other words, the shutter 6 is designed so that it starts to be moved toward the closed position by the α-spring 12 when the shutter 6 is moved for ⅔ of an entire slide distance from the open position in the closing direction by an external force.

As described above, the shutter 6 can also be opened and closed singly. It starts to be automatically urged toward the open or closed position by the urging force of the α-spring 12 while it is sliding in the opening or closing direction. According to the present embodiment, however, the operation for drawing out the handle 4 is utilized as an external force in the shutter closing direction.

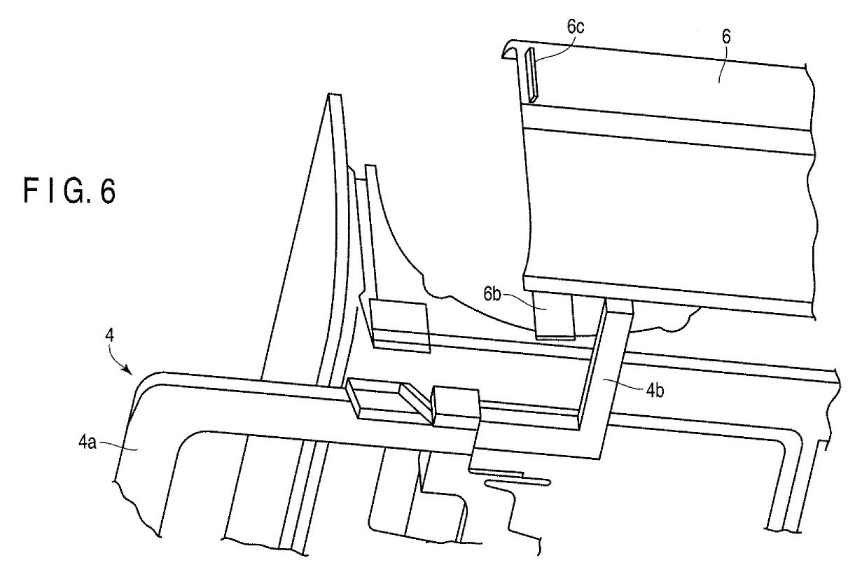

Thus, if the handle 4 in the retracted position is drawn out of the housing of the projector 1 with the shutter 6 located in the open position, the engaging end portion 4b of the handle 4 engages with the engagement piece 6b of the shutter 6, thereby applying an external force in the closing direction to the shutter 6. If the shutter 6 is closed in this state so that it at least gets beyond the aforesaid critical point, the shutter 6 in the state shown in FIG. 6 starts to be automatically moved toward the closed position by the urging force of the α-spring 12 that is deformed in the manner shown in FIG. 5.

According to the present embodiment, the positions of the engaging end portion 4b and/or the engagement piece 6b along the sliding direction are set so that the shutter 6 gets beyond the critical point immediately before the handle 4 is drawn out from the retracted position to the carrying position. In the state shown in FIG. 6, therefore, the handle 4 is fully drawn out to the carrying position. Thus, the stroke at which the handle 4 is drawn out can be set to a necessary minimum, and the shutter 6 can be closed by a minimum necessary handle operation.

By shortening the stroke of the handle 4, moreover, a space for the handle 4 retracted in the housing can be reduced, so that the handle 4 can be prevented from being located near an electronic component that generates much heat, for example. Further, the size of the handle 4 itself can be reduced by shortening the stroke. Accordingly, the material cost can be reduced, so that the manufacturing cost of the apparatus can be reduced, and the apparatus can be made smaller and lighter in weight.

If the shutter 6 is configured to be closed in association with the operation for drawing out the handle 4 to the carrying position, as in the present embodiment, moreover, the shutter 6 can be prevented from failing to be closed while the projector 1 is being carried about. Thus, the lens 2 can be securely protected without being damaged during the transportation of the projector 1.

According to the present embodiment, furthermore, the engaging end portion 4b of the handle 4 releases the engagement piece 6b of the shutter 6 from restriction with the handle 4 retracted in the housing, so that the shutter 6 can also be opened and closed singly. In other words, the shutter 6 can be opened and closed even when the projector 1 is set to an operating state such that the handle 4 is retracted in the housing. Also during this opening and closing operation, the shutter 6 can be automatically opened or closed on the way.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

In connection with the foregoing embodiment, for example, there has been described the case where the present invention is applied to the projector as an electronic apparatus. Alternatively, however, the invention may also be applied to any other electronic apparatus that requires a shutter for protecting a fragile optical member, such as a lens.

In connection with the foregoing embodiment, moreover, there has been described the case where the shutter 6 is closed in association with the operation for drawing out the handle 4 from the left-hand side surface of the housing of the projector 1. Alternatively, however, the invention is also applicable to a projector that is configured so that a handle is drawn out from the right-hand side surface of the housing.

What is claimed is:

1. A closing mechanism for closing a lens shutter, which is movable between a closed position in which a lens of an electronic apparatus is closed and an open position in which the lens is open, to the closed position, comprising:
a handle which is movable between a carrying position outside the electronic apparatus and a retracted position in the electronic apparatus and is used in carrying the electronic apparatus; and
an interlocking mechanism which moves the lens shutter from the opening position toward the closed position in association with an operation for drawing out the handle from the retracted position to the carrying position.

2. A closing mechanism according to claim 1, wherein the interlocking mechanism includes an urging mechanism which urges the lens shutter moving from the open position to the closed position toward the closed position without using any external force, and the lens shutter is automatically moved to the closed position as the lens shutter is moved to a position in which at least an urging force of the urging mechanism starts to act in association with the operation for drawing out the handle.

3. A closing mechanism according to claim 2, wherein the urging mechanism also urges the lens shutter moving from the closed position to the open position toward the open position without using any external force.

4. A closing mechanism according to claim 1, wherein the interlocking mechanism releases the lens shutter from restriction from the closed position toward the open position, thereby enabling an operation for opening and closing the lens shutter, with the handle held in the retracted position.

5. A closing mechanism according to claim 1, wherein the urging mechanism is designed so that the urging force directed to the closed position acts on the lens shutter immediately before the handle is drawn out to the carrying position.
